(19) United States
(12) Patent Application Publication
(10) Pub. No.: US 2018/0200791 A1
(43) Pub. Date: Jul. 19, 2018

(54) DYNAMICALLY DAMPED RECOATER

(71) Applicant: GENERAL ELECTRIC COMPANY, Schenectady, NY (US)

(72) Inventors: MacKenzie Ryan REDDING, Cincinnati, OH (US); Justin MAMRAK, West Chester, OH (US); Zachary David FIELDMAN, Hamilton, OH (US)

(21) Appl. No.: 15/406,336

(22) Filed: Jan. 13, 2017

(51) Int. Cl. B22F 3/105; B29C 67/00; B29C 35/08; B33Y 10/00; B33Y 30/00; B33Y 50/02; B23K 15/00; B23K 15/02; B23K 26/342; B23K 26/70

(52) U.S. Cl. CPC B22F 3/1055; B29C 67/0077; B29C 67/0088; B29C 35/08; B33Y 10/00; B33Y 30/00; B22F 2998/10; B23K 15/0086; B23K 15/02; B23K 26/342; B23K 26/702; B29C 2035/0838; B22F 2003/1057; B33Y 50/02

(57) ABSTRACT

The present disclosure generally relates to additive manufacturing systems and methods involving a recoater blade to smooth out deposited powder, such that the system can sense forces on the blade and allow vertical and horizontal displacement of the blade in response to those forces. The system can change how the blade responds to those forces, for instance the blade may respond by displacing quickly and easily away from the force (a “soft” recoater), or it may resist the force (a “stiff” recoater). This allows a single recoater blade to be used in a variety of situations without work stoppage, whereas before the blade would have to be replaced.

### INTRODUCTION

The present disclosure generally relates to methods and systems adapted to perform additive manufacturing (“AM”) processes, for example by direct melt laser manufacturing (“DMLM”). The process utilizes an energy source that emits an energy beam to fuse successive layers of powder material to form a desired object. More particularly, the disclosure relates to methods and systems that utilize a recoater blade to smooth out the powder, such that the system can sense forces on the blade and allow vertical and horizontal displacement of the blade in response to those forces.

### BACKGROUND

A description of a typical laser powder bed fusion process is provided in German Patent No. DE 19649865, which is incorporated herein by reference in its entirety. AM processes generally involve the buildup of one or more materials to make a net or near net shape (NNS) object, in contrast to subtractive manufacturing methods. Though “additive manufacturing” is an industry standard term (ASTM F2792), AM encompasses various manufacturing and prototyping techniques known under a variety of names, including freeform fabrication, 3D printing, rapid prototyping/tooling, etc. AM techniques are capable of fabricating complex components from a wide variety of materials. Generally, a freestanding object can be fabricated from a computer aided design (CAD) model. A particular type of AM process uses an energy directing device that directs, for example, an electron beam or a laser beam, to sinter or melt a powder material, creating a solid three-dimensional object in which particles of the powder material are bonded together. Different material systems, for example, engineering plastics, thermoplastic elastomers, metals, and ceramics are in use. Laser sintering or melting is a notable AM process for rapid fabrication of functional prototypes and tools. Applications include direct manufacturing of complex workpieces, patterns for investment casting, metal molds for injection molding and die casting, and molds and cores for sand casting. Fabrication of prototype objects to enhance communication and testing of concepts during the design cycle are other common usages of AM processes.

Selective laser sintering, direct laser sintering, selective laser melting, and direct laser melting are common industry terms used to refer to producing three-dimensional (3D) objects by using a laser beam to sinter or melt a fine powder. For example, U.S. Pat. No. 4,863,538 and U.S. Pat. No. 5,460,758, which are incorporated herein by reference, describe conventional laser sintering techniques. More accurately, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Although the laser sintering and melting processes can be applied to a broad range of powder materials, the scientific and technical aspects of the production route, for example, sintering or melting rate and the effects of processing parameters on the microstructural evolution during the layer manufacturing process have not been well understood. This method of fabrication is accompanied by multiple modes of heat, mass and momentum transfer, and chemical reactions that make the process very complex.

FIG. 1 is schematic diagram showing a cross-sectional view of an exemplary conventional system 100 for direct metal laser sintering (“DMLS”) or direct metal laser melting (DMLM). The apparatus 100 builds objects, for example, the part 122, in a layer-by-layer manner by sintering or melting a powder material (not shown) using an energy beam 136 generated by a source such as a laser 120. The powder to be melted by the energy beam is supplied by reservoir 126 and spread evenly over a powder bed 114 using a recoater arm 116 travelling in direction 134 to maintain the powder at a level 118 and remove excess powder material extending above the powder level 118 to waste container 128. The energy beam 136 sinters or melts a cross sectional layer of the object being built under control of the galvo scanner 132. The powder bed 114 is lowered and another layer of powder is spread over the powder bed and object being built, followed by successive melting/sintering of the powder by the laser 120. The process is repeated until the part 122 is completely built up from the melted/sintered powder material. The laser 120 may be controlled by a computer system including a processor and a memory. The computer system may determine a scan pattern for each layer and control laser 120 to irradiate the powder material according to the scan pattern. After fabrication of the part 122 is complete, various post-processing procedures may be applied to the part 122. Post processing procedures include removal of excess powder by, for example, blowing or vacuuming. Other post processing procedures include a stress release process. Additionally, thermal and chemical post processing procedures can be used to finish the part 122. The energy beam 136 must scan a relatively large angle θₐ to build a relatively large part, because θₐ becomes largest xy cross sectional area of the object to be built becomes larger. When an energy beam must scan a relatively large angle, the quality of the part suffers.

Problems in prior art systems and methods, especially for building large parts, are disclosed in, for example, the following applications:

U.S. patent application Ser. No. ______, titled “Additive Manufacturing Using a Mobile Build Volume,” with attorney docket number 037216.00059, and filed Jan. 13, 2017. Jan. 12, 2017.

U.S. patent application Ser. No. ______, titled “Additive Manufacturing Using a Mobile Scan Area,” with attorney docket number 037216.00060, and filed Jan. 13, 2017.

U.S. patent application Ser. No. ______, titled “Additive Manufacturing Using a Dynamically Grown Wall,” with attorney docket number 037216.00061, and filed Jan. 13, 2017.

U.S. patent application Ser. No. ______, titled “Additive Manufacturing Using a Selective Recoater,” with attorney docket number 037216.00062, and filed Jan. 13, 2017.

U.S. patent application Ser. No. ______, titled “Large Scale Additive Machine,” with attorney docket number 037216.00071, and filed Jan. 13, 2017.

The disclosure of each of these applications its incorporated herein in its entirety.

A problem that arises when making large parts of high quality is that, over the course of the build (which may be on the order of hours, days, weeks, or even months), the recoater blade may encounter surface features of the object being formed. Since the recoater blade is generally rigid so that it can smooth out the powder into a substantially even layer, if it encounters a surface feature the recoater blade may become damaged, or it may damage the surface feature. If the recoater blade is damaged, then the process may need to be stopped so that the blade can be replaced, and the entire system will have to be reset and started again. This results in a significant loss in production efficiency. If the surface feature of the object is damaged, the object maybe have to be discarded and rebuilt. Sometimes neither the blade nor the surface feature becomes damaged, but the surface feature stops the recoater from moving further (i.e. it becomes “jammed”), which can damage the equipment that moves the recoater, and can also lead to significant loss of build time. These situations are highly undesirable in general, but they are particularly undesirable when making objects for purposes other than prototyping, such as large, high-quality objects for use in engines, such as an internal combustion engine. Therefore there is a need for a recoating system and apparatus that is less prone to letting the blade and/or surface features of the objects become damaged, and is less prone to becoming jammed.

### SUMMARY OF THE INVENTION

The present invention is related to an apparatus that reduces the aforementioned undesirable situations. An embodiment of the present invention is related to an apparatus for making an object from powder comprising an energy directing device, a powder dispenser, and a recoater blade positioned to provide a layer of powder over a work surface by moving over the work surface, the thickness of the layer of powder determined by the height of the blade tip above the work surface, wherein the recoater blade is mounted to allow movement of the blade height with respect to the work surface while providing the layer of powder over the work surface.

The present invention also relates to a method of fabricating an object involving providing at least one layer of powder in a build area by passing a recoater over the build area, irradiating at least a portion of the layer of powder to form a fused region, and repeating until at least a portion of the object is formed.

The build area contains a work surface, and the recoater comprises a recoater blade positioned over the work surface, the thickness of the layer of powder determined by the height of the blade tip above the work surface, and wherein the recoater blade is mounted to allow movement of the blade height with respect to the work surface while providing the layer of powder over the work surface.

The apparatus may further comprise a blade actuator, wherein the recoater blade is connected to the blade actuator. The blade actuator may be any actuator suitable for controlling the blade's motion in response to a force, for instance the blade actuator may be an electric actuator or a pneumatic actuator. The apparatus may further comprise an actuator controller connected to the blade actuator to move the recoater blade in response to a signal and provide feedback regarding movement of the recoater blade.

The apparatus may further comprise a blade movement element adapted to allow movement of the recoater blade height. For instance, the blade movement element may be a pivot arm or a linear guide.

The energy directing device may comprise at least one optical control unit. The optical control unit may comprise at least one optical element. Illustrative nonlimiting examples of optical elements include mirrors, deflectors, lenses, and beam splitters. The energy directing device may direct an e-beam or a laser beam. An e-beam is a well-known source of irradiation. For example, U.S. Pat. No. 7,713,454 to Larsson titled “Arrangement and Method for Producing a Three-Dimensional Product” (“Larsson”) discusses e-beam systems, and that patent is incorporated herein by reference.

In one embodiment, the blade actuator is attached to a housing, there are one or more actuator arm(s) connected to the recoater blade on one side and to the blade pivot actuator on the other side, there are first and second vertical pivot arms holding the blade portion on one side and connected to first and second horizontal pivot arms by first and second horizontal pivot joints on the other side, wherein the first and second horizontal pivot arms are connected to the housing by first and second vertical pivot joints, and wherein the pivot joints allow movement of the recoater blade height with respect to the work surface.

### SUMMARY OF THE FIGURES

FIG. 1 is a conventional additive manufacturing apparatus according to the prior art.

FIGS. 2A and 2B show frontal and side views respectively of a conventional, fixed recoater according to the prior art.

FIG. 2C shows what may happen when a fixed recoater according to the prior art encounters a hard surface feature.

FIGS. 3A and 3B show frontal and side views respectively of a dynamically damped recoater according to an embodiment of the invention.

FIGS. 4A and 4B show what may happen when a dynamically damped recoater according to an embodiment of the invention encounters a hard surface feature.

FIG. 5 is a large-scale additive manufacturing apparatus comprising a mobile additive manufacturing unit and a 3D precision positioning system over an object according to an embodiment of the invention.

FIGS. 6A and 6B are more detailed views of the mobile additive manufacturing unit, showing a gate plate open and a gate plate closed.

### DETAILED DESCRIPTION OF THE INVENTION

The detailed description set forth below in connection with the appended drawings is intended as a description of various configurations and is not intended to represent the only configurations in which the concepts described herein may be practiced.

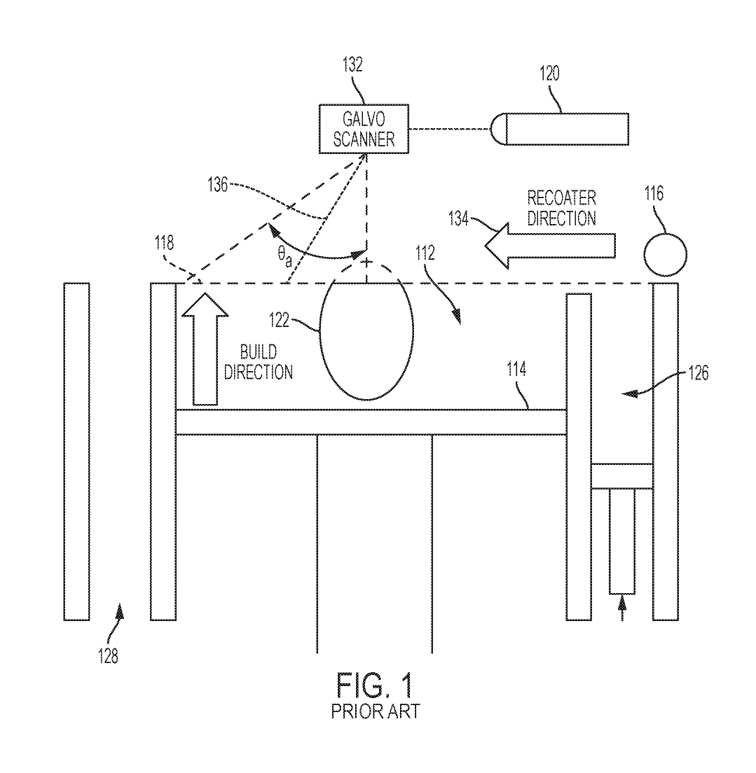

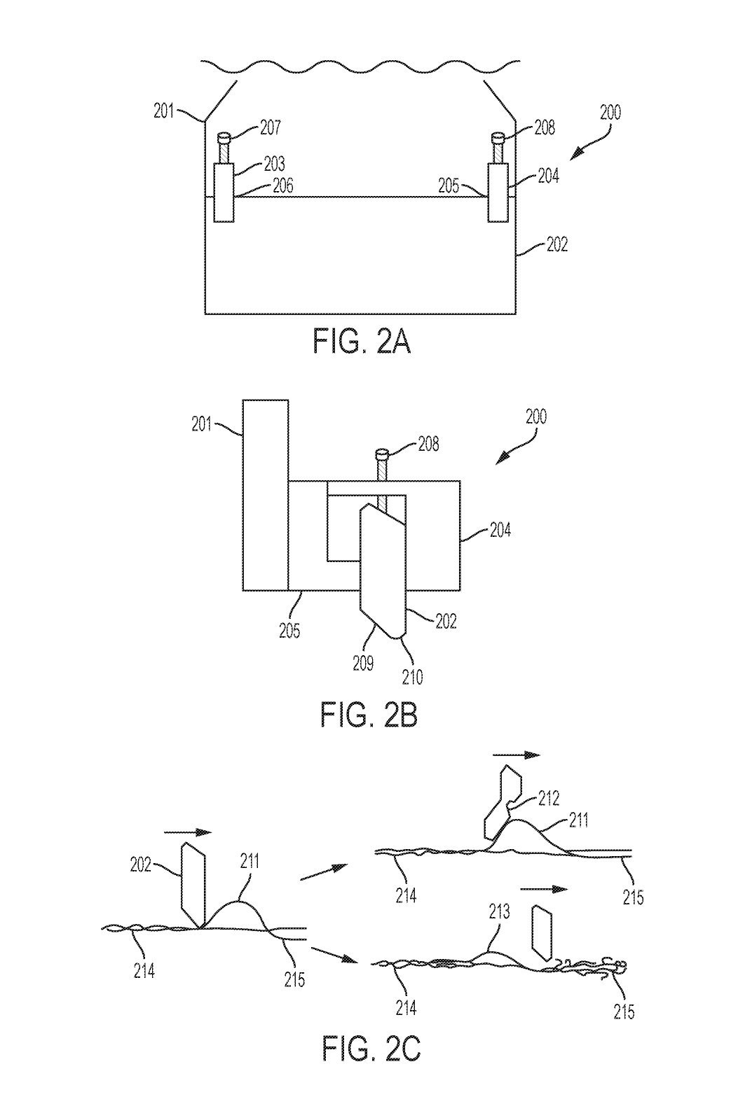

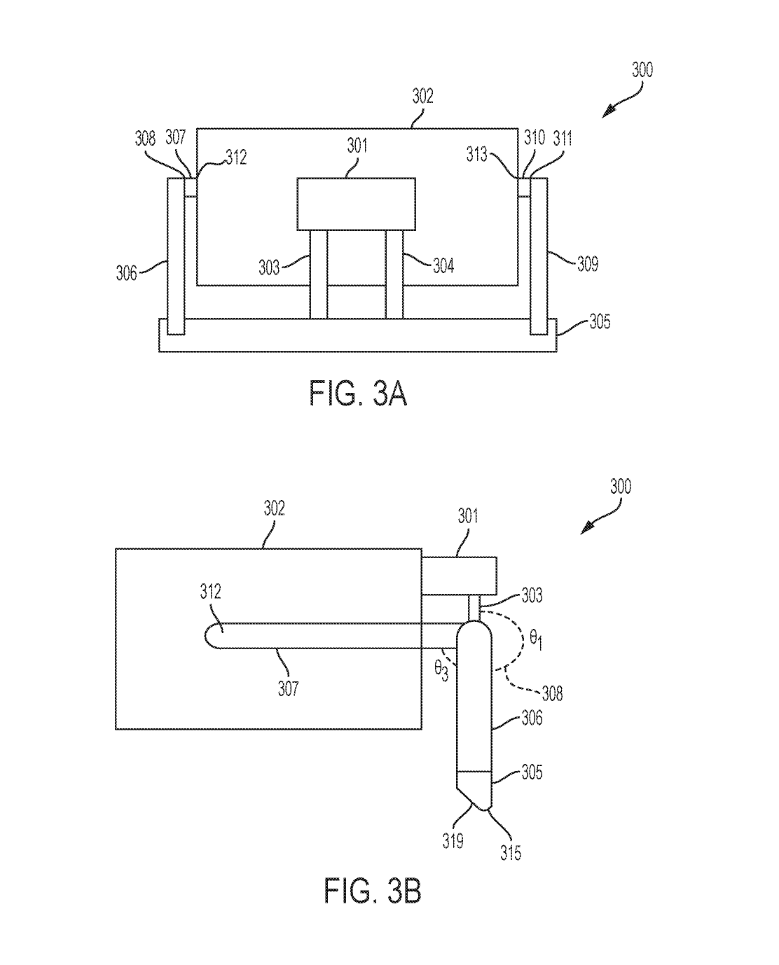

In one embodiment of the present invention the methods and systems of the prior art, one example of which is shown in FIG. 1, are improved on by using a dynamically damped recoater, such as for example one of the dynamically damped recoaters illustrated in FIGS. 3A-4B and 6A-6B. In conventional systems such as those illustrated in FIG. 1, typically a fixed recoater is used, such as those illustrated in FIGS. 2A (frontal view) and 2B (side or profile view). As shown in FIGS. 2A and 2B, a conventional recoater 200 comprises a recoater arm 201, a recoater blade 202, frontal clamp pieces 203 and 204, rear clamp pieces 205 and 206, and screws 207 and 208 that hold the blade 202 in place. The bottom of the blade 202 has a slant 209 and a beveled feature 210. As shown in FIG. 2C, when a conventional recoater experiences a force, for instance by encountering a surface feature 211, neither the recoater arm nor the recoater blade is easily displaceable away from the force, such that there may be at least one of at least two undesirable results. As shown at the top of right of FIG. 2C, if the recoater blade is not rigid enough relative to the hardness of the surface feature 211, then the recoater blade may become damaged or break, as shown by element 212. Alternatively, as shown at the bottom of FIG. 2C, if the recoater blade is too rigid relative to the hardness of the surface feature 211, then it may damage or break the surface feature 211, resulting in a damaged surface feature 213. This view also shows a smoothed layer of deposited powder 214 and an unsmoothed layer of deposited powder 215. A damaged surface feature, such as 213, may result in a low-quality part that has to be discarded and remade, resulting in a substantial loss of time and resources. A third result, not illustrated here, is that the force exerted by the surface feature simply stops the recoater completely, without anything breaking, i.e. it becomes “jammed.” If a human operator is not monitoring the build process carefully, this situation could go undetected, resulting in damage to the entire apparatus and a significant loss of time. In general, the operator must choose the recoater blade in advance of the build operation, so the stiffness of the blade may not be optimal for all situations encountered during the recoating process.

On the other hand, recoaters according to the present invention are capable of responding to a force, such as that exerted upon encountering a surface feature, by displacing the recoater blade away from the force. A dynamically damped recoater according to one embodiment of the present invention is shown in FIGS. 3A (frontal view) and 3B (side or profile view). The dynamically damped recoater 300 has a blade pivot actuator 301 mounted to a housing 302, a first blade pivot actuator arm 303 and a second blade pivot actuator arm 304 both connected to a recoater blade 305, a first vertical pivot arm 306 holding the blade 305, a first horizontal pivot arm 307 connected to the first vertical pivot arm 306 by a first horizontal pivot joint 308 that allows rotation of the first horizontal pivot arm 307 with respect to the first vertical pivot arm 306. There is also a second vertical pivot arm 309 connected to a second horizontal pivot arm 310 by a second horizontal pivot joint 311 that allows rotation of the second horizontal pivot arm 310 with respect to second vertical pivot arm 309. Both the first horizontal pivot arm 307 and the second horizontal pivot arm 310 are connected to the housing 302 by first and second vertical pivot joints respectively (312 and 313) that allow rotation of their respective horizontal pivot arms with respect to the housing 302. The recoater blade has a slant 314 and a beveled feature 315. When the recoater 300 is under no external force, the first and second vertical pivot arms 306 and 309 make an angle θ₃ with first and second horizontal pivot arms 307 and 310, and the first and second vertical pivot arms 306 and 309 make an angle θ₁ with the actuator arms 303 and 304. Preferably, the horizontal pivot arms 307 and 310 are oriented perpendicular to the force of gravity, i.e. parallel to the surface being recoated, and in this configuration θ₃ is preferably greater than 90 degrees so that force exerted by a surface feature against the blade (which will generally be predominantly in the xy plane) is more efficiently transferred from the blade 305 to the actuator arms 303 and 304. In general θ₁ is preferably 180 degrees, so that force is efficiently transferred from the actuator arms 303 and 304 to the blade pivot actuator 301.

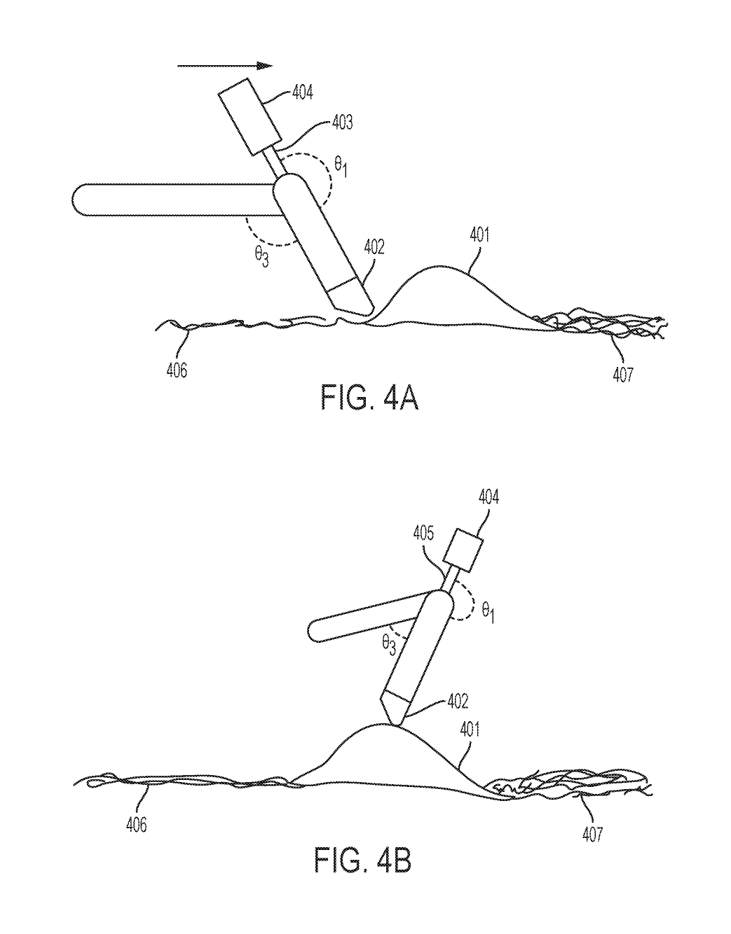

FIGS. 4A-4B illustrates what happens when a dynamically damped recoater according to an embodiment of the invention encounters a surface feature 401. As the recoater blade 402 pushes against the surface feature 401, there is a force on the blade that is transmitted to at least one actuator arm 403, which is transmitted to the blade pivot actuator 404. The blade pivot actuator 404 is physically configured such that, as the force on the blade 402 becomes larger, the actuator arms are allowed to move up into the body of the blade pivot actuator 404, which allows the blade to move upward and away from the surface feature 401. As shown in FIG. 4A, just before the blade 402 encounters the surface feature 401, θ₃ is greater than 90 degrees. When the blade 402 encounters the surface feature 401, it pushes up against the actuator arm 403, which moves up into the blade pivot actuator 404. When this happens the visible portion of the actuator arm shortens, as shown by element 405 (not drawn to scale). Also, the angle θ₃ generally decreases. The device can be physically configured to maintain the angle θ₁ as close to 180 degrees as possible, or the actuator 404 can be fixedly mounted to the same housing as the horizontal pivot arms, such that θ₁ increases by about the same amount that θ₃ decreases. This view also shows a smoothed layer of deposited powder 406 and an unsmoothed layer of deposited powder 407.

There is an actuator parameter that can be set such that, when the blade experiences a force, the actuator senses the force, and allows the blade to be displaced away from the direction of the force by an amount related to the magnitude of the force. For example, if a very “stiff” recoater blade is desired, the actuator parameter can be set such that the blade is displaced very little even in response to a large force. If a “flexible” recoater blade is desired, the actuator parameter can be set such that the blade is easily displaced in response to even a small force. One feature of the present invention is that the actuator parameter is dynamic. In other words, the actuator parameter can be changed in response to the magnitude of the force, i.e. “dynamic damping.” This is highly desirable because, for very low forces, a very stiff, rigid recoater blade is often desired in order to produce very flat, even powder surfaces. At a high level of force, there is a risk that the blade will break, or the surface feature against which the blade is pushing will be broken or otherwise damaged. If the blade breaks, then the process may need to be stopped and the blade replaced, resulting in a loss of efficiency, production time, and resources. If the surface feature is damaged, it could compromise the quality and integrity of the object being manufactured. Part quality and integrity is critical in some applications, such as in the aviation industry where parts must meet strict quality standards. If time and effort are invested into making an aviation part, and then testing reveals that an overly stiff recoater blade has damaged the part, there may be a significant loss of time, money, and resources. Therefore, at high forces it is desirable that the recoater blade become more flexible to avoid damaging either the blade or the object, and the associated loss of production efficiency. In the present invention, the blade stiffness can be dynamically damped by either a human operator and/or a blade actuator control unit (such as a computer), both of which may change the actuator parameter (and thus the blade stiffness) in response to the force on the blade.

The blade pivot actuator may be a pneumatic actuator in which the actuator arms comprise pistons connected to gas cylinders at a certain pressure. The pressure inside the gas cylinder is directly related to its potential energy. When a force is applied to the actuator arms the pressure inside the gas cylinders increases (i.e., there is a back-pressure) and, in response, gas may be released from the cylinders, allowing the actuator arms/pistons to slide into the gas cylinders, which allows the blade to move away from the source of the force (which may be a surface feature). If gas is released quickly from the cylinders, the blade will move relatively quickly and easily away from the force. If gas is released slowly (or not at all) from the cylinders, the blade will move comparatively less in response to a force. In this embodiment, the pressure inside the gas cylinders is the actuator parameter and can be detected by a sensor. The force exerted on the inside of the cylinder can also be detected, since force and pressure are directly related given a particular piston size. When the apparatus is under no external forces, the pressure P₀ sets the default “stiffness” or “compliance” of the recoater blade, i.e. the rate and extent to which the blade will be displaced by a particular amount of force. If a very “stiff” or “less compliant” blade is desired for a particular operation, then P₀ can be set relatively high, and the blade will move relatively slowly and relatively little even in response to a relatively large force. If a very “flexible” or “highly compliant” blade is desired, then P₀ can be set relatively low, such that the blade will move relatively quickly and relatively more, even in response to a weak force. One feature of this embodiment of the present invention is that the degree of compliance of the blade can be changed during the build process, in response to force on the blade, by releasing gas from or forcing gas into the gas cylinders, i.e. “dynamic damping” of the recoater blade. This allows systems and methods according to embodiments of the present invention to handle even unexpected situations during the build operation, and thus reduces damage to the part and to the recoater blade.

In an embodiment, the blade pivot actuator may be an electric actuator comprising an electromagnetic element such as, by way of nonlimiting exemplary illustration only, a voice coil, solenoid, electromagnetic coil, or linear rail. In such a configuration there are actuator arms connected to the electromagnetic element in a close current control loop. The voltage on the electromagnetic element is the actuator parameter in this configuration, and is directly related to its potential energy. If there is a force on the blade, the actuator arms are pushed up against the electromagnetic element, such that a back electromotive force (current) is induced. If the voltage on the electromagnetic element is large, the electromagnetic element will not allow the actuator arms to move up very much, and the recoater blade will have low compliance, i.e. be very “stiff” If the voltage is low, the arms can move up more freely, and the recoater blade will be relatively compliant or “flexible.” The back electromotive force or current may be detected by a sensor. Alternatively the change in voltage may be detected, since current and voltage are directly related for a given system. Depending on the magnitude of the back electromotive force, the voltage on the electromagnetic element may be increased or decreased. For instance, if there is a large electromotive force, there may be a higher risk of damaging either the blade or the surface feature over which the blade is moving, and the voltage on the electromagnetic element may be decreased to make the blade more flexible. On the other hand, for a small electromotive force, it may be desirable to maintain a relatively stiff blade, so that a flat and level surface is created and maintained. Therefore the degree of compliance of the blade can be changed during the build process, in response to force on the blade, by releasing gas from or forcing gas into the gas cylinders, i.e. “dynamic damping” of the recoater blade. This allows systems and methods according to embodiments of the present invention to handle even unexpected situations during the build operation, and thus reduces damage to the part and to the recoater blade.

The blade pivot actuator can be monitored and controlled by a human and/or a computer, such that the actuator parameter can be measured and changed by a human and/or a computer.

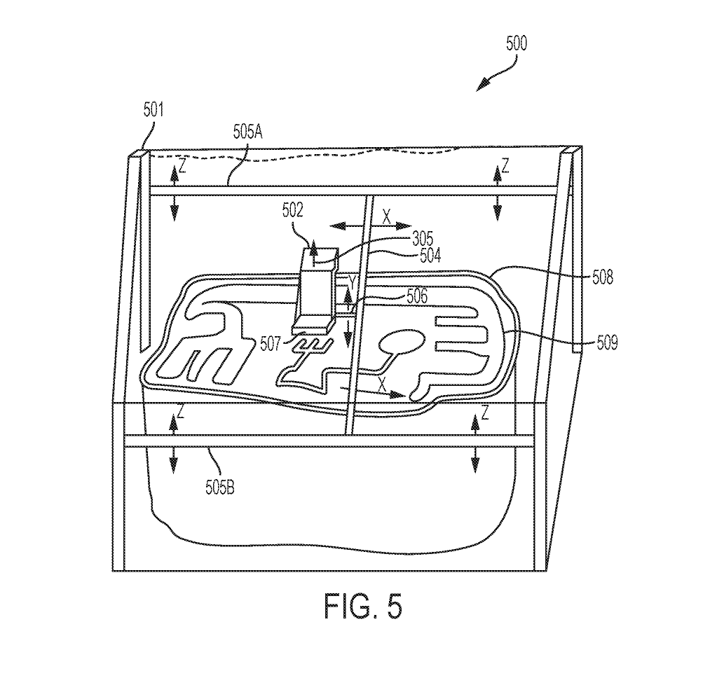

FIG. 5 shows a large scale additive manufacturing machine 500 according to an embodiment of the invention. There is a 3D precision positioning system 501, a mobile additive manufacturing unit 502, and an object being formed 503. There is an x crossbeam 504 that moves the mobile additive manufacturing unit 502 in the x direction. There are two z crossbeams 505A and 505B that move the additive manufacturing unit 502 and the x crossbeam 504 in the z direction. The x cross beam 504 and the mobile additive manufacturing unit 502 are attached by a mechanism 506 that moves the mobile additive manufacturing unit 502 in the y direction.

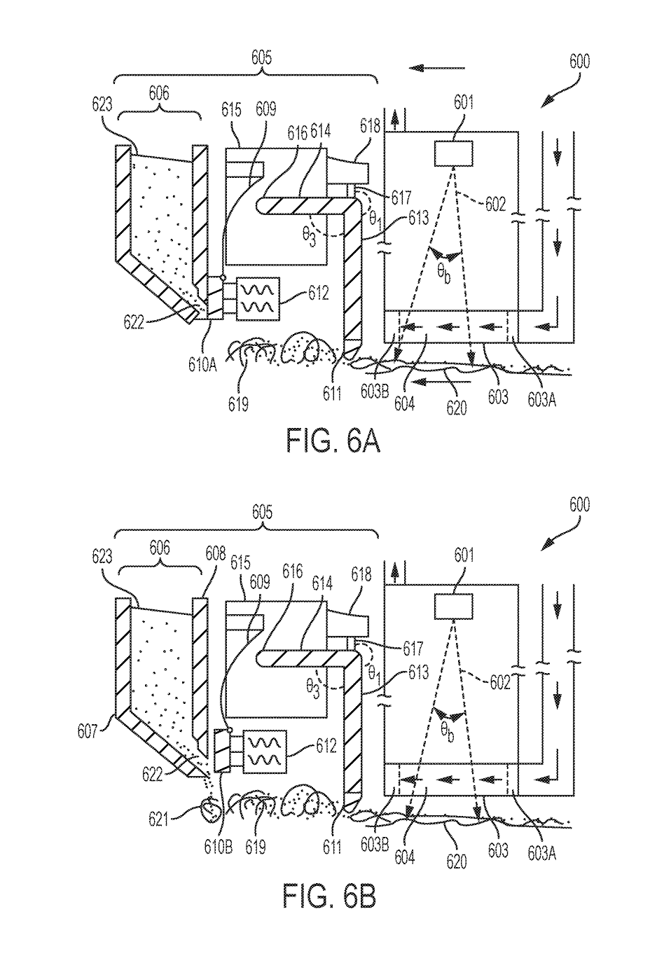

FIGS. 6A-6B is a more detailed view of the mobile additive manufacturing unit shown schematically in FIG. 5. In this particular illustration of one embodiment of the present invention, the mobile additive manufacturing unit 600 has an optical control unit such as a galvo or scanner 601 which may direct an energy beam 602, a gasflow device 603 with a pressurized outlet portion 603A and a vacuum inlet portion 603B providing gas flow to a build volume 604, and a recoater 605. The recoater 605 has a hopper 606 comprising a back plate 607 and a front plate 608. The recoater 605 also has a hopper gate control unit comprising at least one actuating element 609, at least one gate plate represented in the closed position by 610A and the open position in 610B, a recoater blade 611, and a gate plate actuator 612. The recoater 605 also comprises a vertical pivot arm 613 connected to the blade 611 and to a horizontal pivot arm 614 by a horizontal pivot joint 615. The horizontal pivot arm 614 is also connected to a housing 615 by a vertical pivot joint 616. There is also an actuator arm 617 connected to the blade 611 and to a blade pivot actuator 618. This depiction shows unsmoothed deposited powder 619, smoothed deposited powder 620, and newly deposited powder 621. During operation, the energy beam scans through a maximum angle θ_{b} that is determined by the distance from the optical control unit 601 to the surface of the smoothed deposited powder 620, and the distance from the pressurized outlet portion 603A to the vacuum inlet portion 603B. In this particular embodiment, the gate plate actuator 612 activates the actuating element 609 to pull the gate plate 610 away from the front plate 608. There is a hopper gap 622 between the front plate 608 and the back plate 607 that allows powder to flow if there is an open gate plate 610B. The hopper gap 622 may be, for instance, about 0.012 inches. There may be as many gate plates and actuating elements as desired, and each can be controlled (opened and closed) independently of the others to deposit powder in particular locations for particular lengths of time. The hopper contains powder 623, which may be the same material as the back plate 607, the front plate 608, and the gate plate 610. Alternatively, the back plate 607, the front plate 608, and the gate plate 610 may all be the same material, and that material may be one that is compatible with the powder material 618. In this particular illustration of one embodiment of the present invention, the gas flow in the build volume 604 flows in the same direction in which the mobile additive manufacturing unit 600 moves, but this is not required for the present invention. The angles θ₁ and θ₃ are not particularly limited, and the illustration in FIG. 3 is not meant to imply that θ₁ must always be 180 degrees, or that θ₃ must always be 90 degrees. In general, it is preferably that θ₃ is greater than 90 degrees. It is also preferable that θ₁ is 180 degrees if possible, but these angles are not required for the present invention to function as intended.

The previous illustrations and description focus on using pivot joints to allow the blade to move, but that is just for ease of illustration. The present invention is not limited to that mechanism. Persons of ordinary skill can readily envision other methods of making the blade movable, for instance using linear guides. The guides could also be dynamically damped by suitable means, as one of ordinary skill would readily appreciate from the present disclosure.

Some embodiments of the present invention also relate to methods and systems for performing additive manufacturing using a dynamically damped recoater as already described. For instance, an embodiment of the invention relates to a method of fabricating an object by providing a layer of powder in a build area defining an xy plane using a dynamically damped recoater, irradiating the layer of powder to form a fused region, and repeating until the object is formed.

An embodiment of the invention also relates to a method of fabricating an object by defining two or more build regions in a build area defining an xy plane, providing a layer of powder within one of the two or more build regions by passing a dynamically damped recoater over that build region, irradiating the layer of powder to form a fused region, moving the recoater to another one of the original two or more build regions, then repeating the steps of providing a layer of powder in the build region, irradiating the layer of powder to form a fused region, and moving the recoater to another one of the original two or more build regions, until each of the two or more build regions contains a fused region. Then the entire process is repeated, beginning with defining two or more build regions, until the desired object or objects is/are formed. Before repeating the entire process, the recoater may be moved upward in the z direction by a distance that may be approximately equal to the layer thickness.

An embodiment of the invention also relates to a method of fabricating an object by defining two or more build regions in a build area defining an xy plane, providing a layer of powder within one of the two or more build regions by passing a dynamically damped recoater over that build region, irradiating the layer of powder to form a fused region, then repeating the steps of providing a layer of powder and irradiating the layer of powder to form a fused region, until a desired portion of the formed object is formed. Before repeating these steps, the recoater may be moved upward in the z direction by a distance that may be approximately equal to the layer thickness. Then the recoater is moved to another one of the original two or more build regions, and the entire process is repeated for each build region, until the desired object is formed. In this embodiment,

The present invention also relates to an apparatus that can be used to perform additive manufacturing, including the additive manufacturing methods described above. The apparatus comprises a build plate defining an xy plane, a mobile additive manufacturing unit, and an energy source. The mobile additive manufacturing unit comprises an optical control unit (such as a galvo or scanner). The mobile additive manufacturing unit may also comprise any one or more of a gasflow device, a recoater, and a build envelope. The mobile additive manufacturing unit may be mounted to a 3D precision positioning system. The energy source can be any device suitable for creating a fused region, such as a laser, or an electron beam apparatus such as an electron gun. The optical control unit may comprise one or more optical elements. Optical elements include, for example, lenses, deflectors, mirrors, and beam splitters.

The formed object may have a largest xy cross sectional area AO that is no less than about 500 mm², or preferably no less than about 750 mm², or still more preferably no less than about 1 m². There is no particular upper limit on the size of the object. It can be, for example, as large as 100 m². Likewise, there is no particular upper limit on the largest xy cross sectional area of the build area AB. AB may be as small as, for example, 39 inches by 12 inches (i.e. the largest dimension of the build area in the x direction, WB, by the largest dimension of the build area in the y direction, LB). AB may be as large as, for example, 150 feet by 50 feet. Further, there is no particular upper limit on the largest xy cross sectional area of the build plate (AP), except the size of the build plate that can be obtained and maintained. AP may be as small as, for example, 39 inches by 12 inches (i.e. the largest dimension of the build plate in the x direction, WP, by the largest dimension of the build plate in the y direction, LP). AP may be as large as, for example, 150 feet by 50 feet (WP by LP). The build plate and the build area may both be larger in the xy plane than the recoater. For instance, the recoater blade may have a largest dimension in the x direction WR and a largest dimension in the y direction LR. WR and LR may both be smaller than any one of WP, LP, WB, and LB. There is no particular upper limit on the size of the build plate and/or the build area relative to the recoater. For instance, WR may be about half, about a quarter, about one tenth, or less than one tenth the size of WP and/or WR. Likewise, LR may be about half, about a quarter, about one tenth, or less than one tenth the size of LP and LR.

The systems and methods of the present invention may use two or more mobile additive manufacturing units to build one or more object(s). The number of mobile additive manufacturing units, objects, and their respective sizes are only limited by the physical spatial configuration of the apparatus.

In an aspect, powder material deposited outside the build plate area is collected and reused or recycled. It may be reused, for instance, by depositing it as a powder layer to form a successive fused region of the object.

Advantageously, in the present invention the build plate does not have to be coupled to a vertical displacement device. This permits the build plate to support as much material as necessary, unlike the prior art methods and systems, which require some mechanism to raise and lower the build plate, thus limiting the amount of material that can be used.

As shown in FIGS. 6A-6B, in some embodiments laminar gas flow can be provided by a gasflow device 603 with a pressurized outlet portion 603A and a vacuum inlet portion 603B providing gas flow to the build volume 604. The gas flows out from the pressurized gas outlet portion into the build volume 604. The gas flows from the build volume 604 into the low-pressure gas inlet portion 603B. The gasflow device, and the build volume, are located above the build area. The build volume is essentially the inner volume of the gasflow device, i.e. the volume defined by the surfaces of the inlet and outlet portions in the z direction, and by extending imaginary surfaces from the respective upper and lower edges of the inlet portion to the upper and lower edges of the outlet portion in the xy plane. When a layer of powder is irradiated, smoke, condensates, and other impurities flow into the build volume, and are transferred away from the powder and the object being formed by the laminar gas flow. The smoke, condensates, and other impurities flow into the low-pressure gas outlet portion and are eventually collected in a filter, such as a HEPA filter. By maintaining laminar flow, smoke, condensates and other impurities can be efficiently removed, and the melt pool(s) can also be rapidly cooled, resulting in higher quality parts with improved metallurgical characteristics.

The step of irradiating the powder can be performed using an energy directing device comprising an energy source and an optical control unit (e.g. scanner or galvo). The energy source produces an energy beam as shown in FIGS. 6A-6B. The energy beam is moved through a relatively small angle θ_{b} relative to the surface of the smoothed deposited powder 620 by the optical control unit to build an object. The direction of the energy beam when θ₂ is about 90 degrees relative to the smoothed deposited powder 620 defines the z direction. Advantageously, a telecentric lens may be used as part of the optical control unit. The point on the powder that the energy beam touches when θ₂ is 90 degrees defines the center of a circle, and the most distant point from the center of the circle where the energy beam touches the powder defines a point on the outer perimeter of the circle. This circle defines an energy beam scan area AS, which may be smaller than the largest xy cross sectional area of the object AO. For example, the ratio of AO to AS may be from about 2 to 1 to about 100 to 1, or preferably about 10 to 1 to about 45 to 1, or most preferably about 13 to 1. There is no particular upper limit on the ratio of AO to AS. For instance, AO may be about as large as 100 times AS.

1. An additive manufacturing apparatus comprising:
an energy directing device;
a powder dispenser; and
a recoater blade with a blade tip, the recoater blade positioned to provide a layer of powder over a work surface by moving over the work surface, the thickness of the layer of powder determined by the height of the blade tip above the work surface, wherein the recoater blade is mounted to allow movement of the blade height with respect to the work surface while providing the layer of powder over the work surface.

2. The apparatus of claim 1, further comprising a blade actuator, wherein the recoater blade is connected to the blade actuator.

3. The apparatus of claim 2, wherein the blade actuator is an electric actuator or a pneumatic actuator.

4. The apparatus of claim 2, further comprising an actuator controller, the actuator controller connected to the blade actuator to move the recoater blade in response to a signal and provide feedback regarding movement of the recoater blade.

5. The apparatus of claim 1, further comprising a pivot arm, the pivot arm adapted to allow movement of the recoater blade height.

6. The apparatus of claim 1, further comprising linear guides, the linear guides adapted to allow movement of the recoater blade height.

7. The apparatus of claim 1, wherein the energy directing device is adapted to direct laser irradiation.

8. The apparatus of claim 1, wherein the energy directing device is adapted to direct e-beam irradiation.

9. The apparatus of claim 7, wherein the energy directing device comprises at least one optical control unit comprising at least one optical element chosen from the list consisting of mirrors, deflectors, lenses, and beam splitters.

10. The apparatus according to claim 1, wherein the blade actuator is attached to a housing, there are one or more actuator arm(s) connected to the recoater blade on one side and to the blade pivot actuator on the other side, there are first and second vertical pivot arms holding the blade portion on one side and connected to first and second horizontal pivot arms by first and second horizontal pivot joints on the other side, wherein the first and second horizontal pivot arms are connected to the housing by first and second vertical pivot joints, and wherein the pivot joints allow movement of the recoater blade height with respect to the work surface.

11. A method of fabricating an object comprising:
(a) providing at least one layer of powder in a build area by passing a recoater over the build area;
(b) irradiating at least a portion of the layer of powder to form a fused region;
(c) repeating steps (a) and (b) to form at least a portion of the object;
wherein the build area contains a work surface, and the recoater comprises a recoater blade positioned over the work surface, the thickness of the layer of powder determined by the height of the blade tip above the work surface, and wherein the recoater blade is mounted to allow movement of the blade height with respect to the work surface while providing the layer of powder over the work surface.

12. The method of claim 11, wherein the recoater further comprises a blade actuator, wherein the recoater blade is connected to the blade actuator.

13. The method of claim 12, wherein the blade actuator is an electric actuator or a pneumatic actuator.

14. The method of claim 12, wherein the recoater further comprises an actuator controller, the actuator controller connected to the blade actuator to move the recoater blade in response to a signal and provide feedback regarding movement of the recoater blade.

15. The method of claim 11, wherein the recoater further comprises a pivot arm, the pivot arm adapted to allow movement of the recoater blade height.

16. The apparatus of claim 11, wherein the recoater further comprises linear guides, the linear guides adapted to allow movement of the recoater blade height.

17. The method of claim 11, wherein step (b) is performed using an energy directing device adapted to direct laser irradiation.

18. The method of claim 11, wherein step (b) is performed using an energy directing device adapted to direct e-beam irradiation.

19. The method of claim 17, wherein the energy directing device comprises at least one optical control unit comprising at least one optical element chosen from the list consisting of mirrors, deflectors, lenses, and beam splitters.

20. The method according to claim 11, wherein the blade actuator is attached to a housing, there are one or more actuator arm(s) connected to the recoater blade on one side and to the blade pivot actuator on the other side, there are first and second vertical pivot arms holding the blade portion on one side and connected to first and second horizontal pivot arms by first and second horizontal pivot joints on the other side, wherein the first and second horizontal pivot arms are connected to the housing by first and second vertical pivot joints, and wherein the pivot joints allow movement of the recoater blade height with respect to the work surface.
